(19) United States
(12) Patent Application Publication
(10) Pub. No.: US 2013/0277514 A1
(43) Pub. Date: Oct. 24, 2013

(54) FRAMING CONNECTOR

(71) Applicant: Milan Mitrovic, Mississauga (CA)

(72) Inventor: Milan Mitrovic, Mississauga (CA)

(21) Appl. No.: 13/450,163

(22) Filed: Apr. 18, 2012

(51) Int. Cl. F16D 1/00; A47B 96/00

(52) U.S. Cl. 248/222.51; 403/16

(57) ABSTRACT

An adjustable angle connector for connecting two framing elements end-to-end. The connector includes connector members pivotably connected together. Anchor members capable of being secured within the framing pieces are attached to respective connector members using fasteners that adjustably secure the connector members and corresponding anchor members a fixed distance apart. The fasteners may be tightened to draw together the framing pieces into a secure end-to-end connection.

### FIELD

The present application generally relates to connectors for attaching two framing pieces and, in one particular case, to attaching two framing pieces end-to-end at an angle.

### BACKGROUND

Connecting two framing pieces typically involves screwing the two pieces together using screws. In some cases, the framing pieces may be formed to have recesses within which the screws are set to hide the appearance of the screws. This is particularly the case with wooden pieces, such as handrails and such. U.S. Pat. No. 5,261,201 provides an example of such a system. U.S. Pat. No. 6,257,799 to Ribe provides another such example system, for use with cylindrical pipes in particular.

In some cases, an overlapping rigid plate or other such structural piece may be used to tie the two framing pieces together. The rigid plate may be screwed into the underside of each of the framing pieces. Provided the plate is formed with the correct angle, the two pieces will be rigidly held in angular relation.

Other connectors for use with hollow cylindrical framing pieces include those which propose attaching two pieces using a resilient dowel piece that fits into two abutting ends of the framing pieces. US Patent Publication 2003/0164488 to Terrels shows a two-part dowel piece with a hinge allowing two framing pieces to be connected end-to-end at an angle. The dowel piece relies upon friction and its resilient structure to hold the two framing pieces together in alignment. Cement or other adhesives may be used in conjunction with friction.

It would be advantageous to provide for an improved connector for connecting framing pieces.

### BRIEF DESCRIPTION OF THE DRAWINGS

Reference will now be made, by way of example, to the accompanying drawings which show example embodiments of the present application, and in which:

FIG. 1 shows plan view of one example embodiment of a connector;

FIG. 2 shows a side view of one example embodiment of the connector;

FIG. 3 shows a side view of another example embodiment of the connector;

FIG. 4 shows one example implementation of a fastener for used in one of the example connectors;

FIG. 5 shows a portion of a further example embodiment of the connector.

FIGS. 6, 7 and 8 show perspective views of example framing pieces having axial channels;

FIG. 9 shows a perspective view of an example embodiment of the connector used to connect two framing pieces together at an angle;

FIG. 10 shows a plan view of the example of FIG. 9;

FIG. 11 shows one example of a connector for connecting a framing piece to a surface;

FIG. 12 shows an example of an off-axis pivot connection between two connector members;

FIG. 13 shows a connector having a fixed angle; and

FIG. 14 shows an example of connector for compound angles.

Similar reference numerals may have been used in different figures to denote similar components.

### DESCRIPTION OF EXAMPLE EMBODIMENTS

In one aspect, the present application describes a connector configured to connect a first and second framing piece end-to-end at an angle, each framing piece having an axial channel that defines an opening in an end of that framing piece. The connector includes a first connector member and a second connector member each having a pivot end, the pivot ends being pivotally attached to each other, wherein the first connector member and the second connector member each have a cross-sectional profile configured to fit within the axial channel of the respective framing pieces. The connector further includes a first anchor member having a cross-sectional profile configured to fit within the axial channel of the first framing piece and having a lock element for securing the first anchor member in place within the first framing piece; a second anchor member having a cross-sectional profile configured to fit within the axial channel of the second framing piece and having a lock element for securing the second anchor member in place within the second framing piece; a first fastener to attach the first connector member to the first anchor member an adjustable longitudinal distance apart; and a second fastener to attach the second connector member to the second anchor member an adjustable longitudinal distance apart.

In another aspect, the present application describes a connector configured to connect a framing piece to another element, the framing piece having an axial channel that defines an opening in an end of that framing piece. The connector includes a pivot member; a connector member having a pivot end, the pivot end being pivotally attached to the pivot member, wherein the connector member has a cross-sectional profile configured to fit within the axial channel of the framing piece; an anchor member having a cross-sectional profile configured to fit within the axial channel of the framing piece and having a lock element for securing the anchor member in place within the framing piece; and a fastener to attach the connector member to the anchor member an adjustable longitudinal distance apart.

In yet a further aspect, the present application describes a connector configured to connect a first and second framing piece end-to-end at an angle, each framing piece having an axial channel that defines an opening in an end of that framing piece. The connector includes an angle connector formed from a single piece having a first arm and a second arm joined at a fixed angle; a first anchor member having a cross-sectional profile configured to fit within the axial channel of the first framing piece and having a lock element for securing the first anchor member in place within the first framing piece; a second anchor member having a cross-sectional profile configured to fit within the axial channel of the second framing piece and having a lock element for securing the second anchor member in place within the second framing piece; a first fastener to attach the first arm of the angle connector to the first anchor member an adjustable longitudinal distance apart; and a second fastener to attach the second arm of the angle connector to the second anchor member an adjustable longitudinal distance apart.

Other aspects and features of the present application will be understood by those of ordinary skill in the art from a review of the following description of examples in conjunction with the accompanying figures.

The present application describes embodiments of a connector for securing two framing pieces end-to-end, i.e. as a butt joint. The framing pieces have longitudinal axial channels or passages within them that are open at the ends to be connected. The connector fits within the longitudinal axial channels of the two pieces and acts to draw together and secure the two framing pieces in fixed angular position. The ends of the framing pieces to be connected may be miter cut at the angles at which they are to join and the connector secures them together with their cut ends abutting each other.

The framing pieces may include c-channel piping or framing. It may include closed hollow rectangular framing. It may include hollow pipe or conduit. In general the framing pieces include any longitudinal member having an axial channel, including longitudinal members in which at least a portion of the channel is open along the length of the member, like a c-channel.

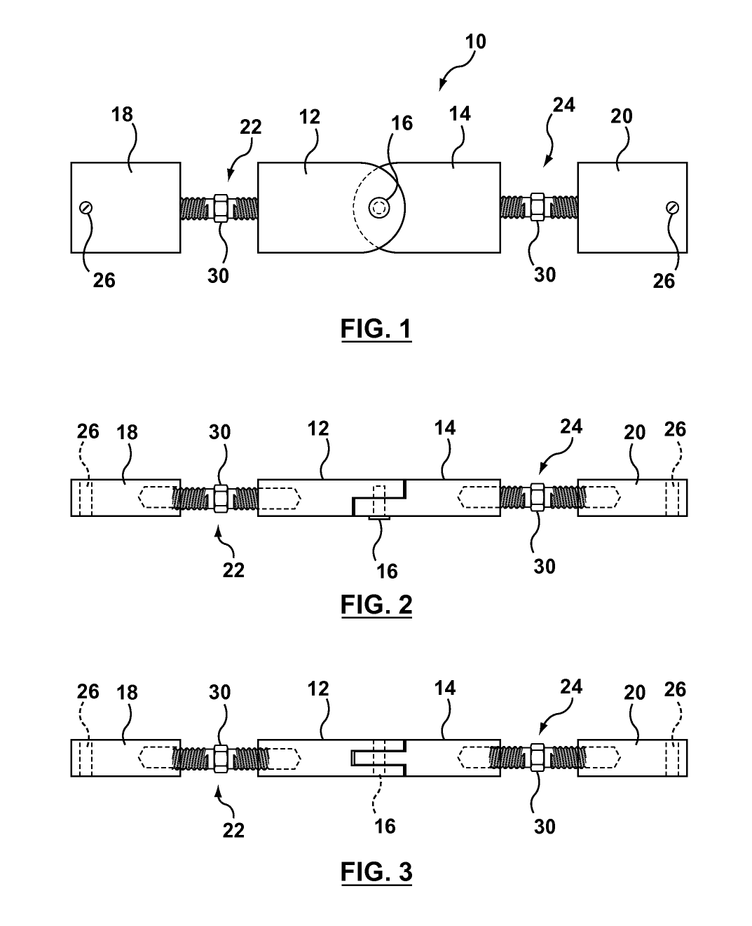

Reference is first made to FIG. 1, which shows a plan view of one embodiment of an example connector 10. The connector 10 includes a first connector member 12 and a second connector member 14 pivotally attached to each other. In this embodiment, the pivot point is provided by a cylindrical shaft 16 connecting the two connector members 12, 14. The first connector member 12 and second connector member 14 are free to pivot relative to each other in the plane transverse to the axis of the cylindrical shaft 16.

Reference is now also made to FIGS. 2 and 3, which show a side view of the example connector 10 in a first and second embodiment, respectively. In the first embodiment shown in FIG. 2, the first connector member 12 and second connector member 14 overlap each other at the pivot point and the cylindrical shaft 16 may be attached to one of the members (the first connector member 12 in FIG. 2) and may have an enlarged head portion to prevent the other member from detachment. The through-hole in the second connector member 14 through which the shaft 16 passes is sized to permit the second connector member 14 to rotate freely around the shaft 16.

In the embodiment shown in FIG. 3, one of the members (the second connector member 14 in this example) has its pivot end nested within the pivot end of the other member. In other words, the pivot end of the second connector member 14 is sandwiched between arms at the pivot end of the first member connector 12. The cylindrical shaft 16 may be attached to either of the connector members 12, 14, provided the other member is free to rotate around the shaft 16.

Referring still to FIGS. 1-3, the example connector 10 also includes a first anchor member 18 and a second anchor member 20. The first and second anchor members 18, 20 are attached to the first and second connector members 12, 14, respectively, using respective first and second fasteners 22, 24. The fasteners 22, 24 are each configured to maintain their respective anchor member 18, 20, and first and second connector members 12, 14 an adjustable longitudinal distance apart. More particularly, the fasteners 22, 24 are adjustable to exert a tightening force drawing respective anchor members 18, 20 and connector members 12, 14 together.

In one embodiment, the fasteners 22, 24 are double-ended bolts with one side of the bolt having opposite rotation threads from the other side, such that when the bolt is turned both ends are advancing into (or withdrawing from) respective cooperating threaded cavities in the anchor member 18, 20 and connector member 12, 14. For example, one end of the bolt may have clockwise threads (right-hand threads) and the other end may have counter-clockwise threads (left-hand threads). Right-hand and left-hand threads are sometimes found together in turnbuckles and clamping studs. In this case, the right and left-hand threads are on either end of a bolt with a central driving portion 30, such as a hex head or other surface capable of receiving a rotational force to drive the bolt. One example embodiment is illustrated later.

Each of the anchor members 18, 20 also includes a lock element 26 for securing the anchor member 18, 20 in place within a framing piece. The lock element 26 secures the anchor member 18, 20 to the framing piece by friction or fixed attachment. In one embodiment, the lock element 26 is a set screw. The set screw is tightened to the point that it secures its respective anchor member 18, 20 by bearing against the inside surface of the framing piece, as will be described further below.

In use, one end of the connector 10 is inserted in the axial channel of one of the framing pieces and the other end of the connector 10 is inserted in the axial channel of the other of the framing pieces. The ends of the framing pieces into which the connector 10 is inserted are brought into alignment, such that they meet at the pivot point of the connector 10 and the desired angle is achieved by abutting the mitered faces of the two framing pieces. The connector 10 is secured to the respective framing pieces by tightening the lock element 26 (such as a set screw or other such element) on each of the anchor members 18, 20, thereby securing the anchor members 18, 20 to their respective framing pieces. The fasteners 22, 24 may then be used to tighten or loosen the connection between the two framing pieces. As the fasteners 22, 24 are tightened, the pivot point is drawn towards the respective anchor member 18, 20, thereby pulling on the corresponding other half of the connector 10 and its framing piece.

The connector 10 thus provides a secure adjustable angular connection between two framing pieces. Because the connector 10 is located within the axial channels of the respective framing pieces, there are no screw holes or welding beads to mar the outward appearance of the framing members (aside from the open c-channel or access holes, as will be further described below). This lends the connector 10 to use in connection with hand-railings and other such structural applications in which smooth upper and side surfaces are desirable.

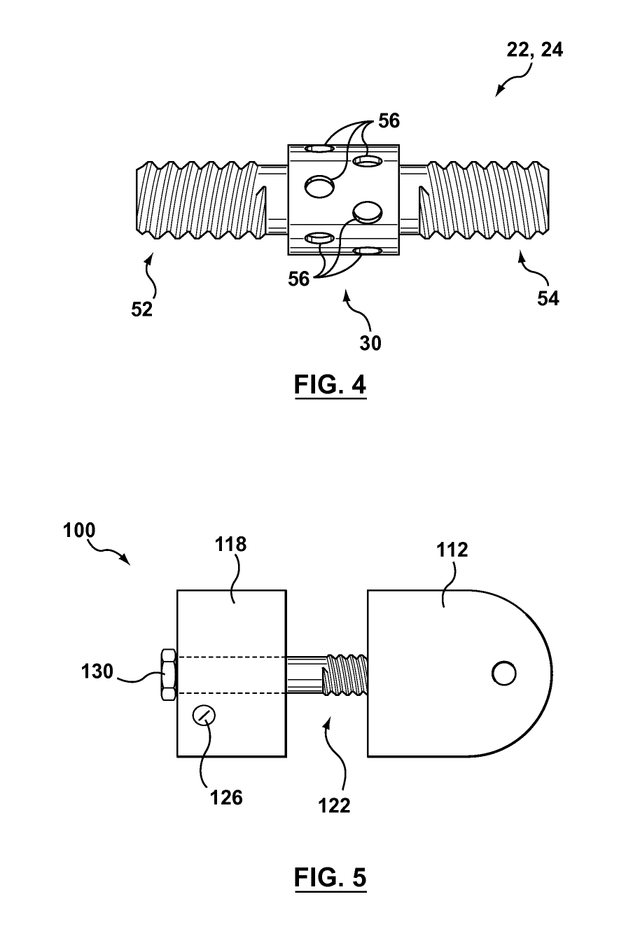

Reference is now made to FIG. 4, which shows a side view of one example embodiment of a fastener 22, 24. The fastener 22, 24 includes an anchor end 52 and a connector end 54. The anchor end 52 is threaded for insertion into a cooperating threaded bolt hole in one of the anchor members 18, 20 (FIG. 1). The connector end 54 is also threaded, but in the opposite direction to the anchor end 52. The connector end 54 is configured to be inserted into a cooperating threaded bolt hole in one of the connector members 12, 14.

In this embodiment, the central driving portion 30 includes a plurality of key holes 56 in the outer surface spaced around the circumference of the central driving portion 30. The key holes 56 may be drilled holes of a depth of a few millimeters. The key holes are sized to accommodate insertion of an elongate lever, such as an Allen key or similar elongate lever, that is then used to impart rotational force upon the bolt. Given the limited access available to the fastener 22, 24 once it is in place within framing piece in many implementations, the use of an insertable lever to incrementally rotate the bolt using the key holes 56 avoids the difficulty of gripping and turning a hex head or similar drive mechanism.

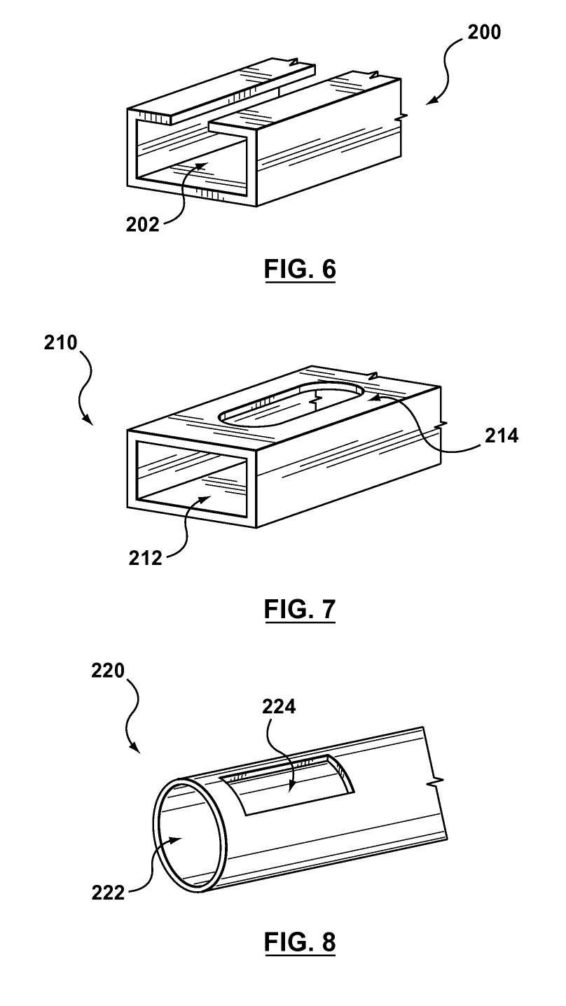

Reference is now made to FIG. 5, which shows a portion of an embodiment of an alternative connector 100. Only half the alternative connector 100 is illustrated in FIG. 6. The alternative connector 100 includes an anchor member 118, a connector member 112, and a fastener 122. In this embodiment, the fastener 122 is a bolt with a driving head 130 and a threaded end. The bolt passes through a through passage in the anchor member 118 and is threaded into a cooperating cavity on the connector member 112.

A lock element 126 (in this case, a set screw) is offset from the center of the anchor member 118 due to the fastener 122 passing through the anchor member 118.

Referring again to FIGS. 1-3, the anchor members 18, 20 and connector members 12, 14 have a cross-sectional profile that allows them to be inserted into the axial channel of the framing pieces with which they are to be used. In many implementations, the outer cross-sectional profile of the connector members 12, 14 and anchor members 18, 20 may generally correspond to an interior profile of the axial channel of the framing pieces; however, the outer cross-sectional profile does not necessarily exactly match the axial channel profile. For example, in some cases, the outer cross-sectional profile could be smaller in one or more dimensions. In some cases, the connector 10 may have an outer cross-sectional profile with an altogether different shape, provided the anchor member 18, 20 is capable of being secured in place. In many instances, having an outer cross-sectional profile with generally the same profile as the interior axial channel profile may improve stability so that lateral shifts of the framing pieces relative to each other do not occur.

Reference is now made to FIGS. 6, 7 and 8, which show examples of framing pieces. FIG. 6 shows a perspective view of a portion of an example c-channel framing piece 200. The connector 10 (FIG. 1) is inserted into axial channel 202. The longitudinal opening that runs the length of the framing piece 200 in communication with the axial channel 202 allows for access to the fastener 22, 24 (FIG. 1) and lock element 26 (FIG. 1).

FIG. 7 shows a perspective view of a portion of another example framing piece 210. The framing piece 210 in this example is a closed channel framing piece. The framing piece 210 features an axial channel 212 running its length. An access aperture 214 is cut in one wall or surface of the framing piece 210 to permit access to the axial channel 212 and, in particular, to the fastener 22, 24 (FIG. 1) and lock element 26 (FIG. 1) when the connector 10 (FIG. 1) is inserted. In some cases, more than one access aperture 214 may be formed in the framing piece 210 so as to separately provide access to the fastener 22, 24 and lock element 26.

FIG. 8 shows a perspective view of a portion of another example framing piece 220. This framing piece 220 is a closed tube having a cylindrical axial channel 222 and an access aperture 224. The connector, in this embodiment, may have rounded connector members and anchor members to correspond to the circular interior profile of the axial channel 222.

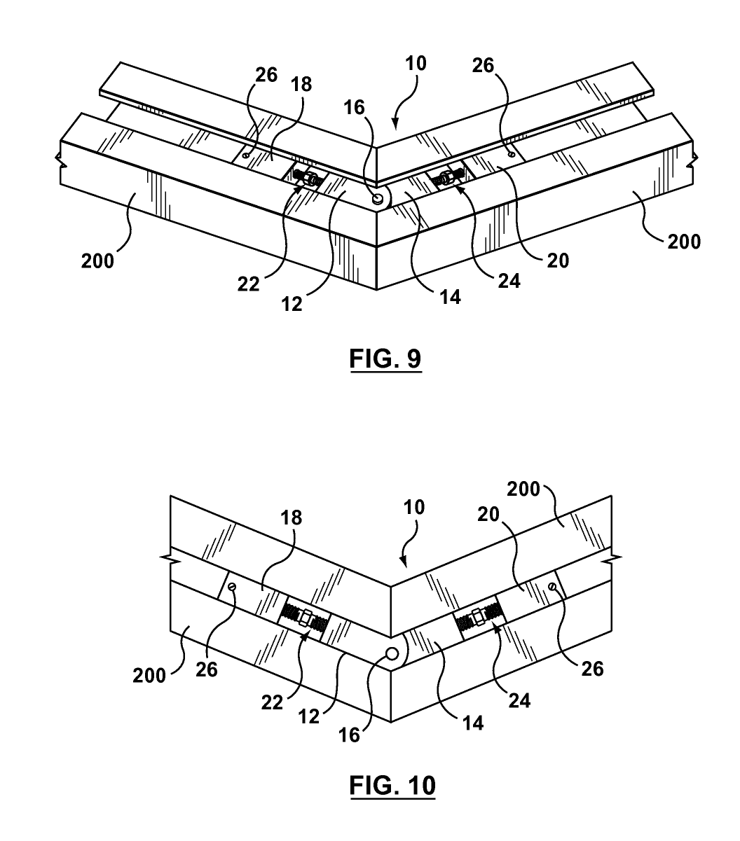

Reference is now made to FIGS. 9 and 10, which show one example of an embodiment of the connector 10 inserted within and joining two example framing pieces 200. The framing pieces 200 in this example are rectangular c-channel framing pieces joined at a mitered angle. The connector 10 in this example corresponds to the connector 10 illustrated and described in connection with FIG. 1. It will be noted that the longitudinal opening gives access to the lock elements 26 so that the connector 10 can be secured in place at its anchor members 18, 20. The framing pieces are then drawn together into a tight abutting connection at their respective mitered ends by tightening the fasteners 22, 24.

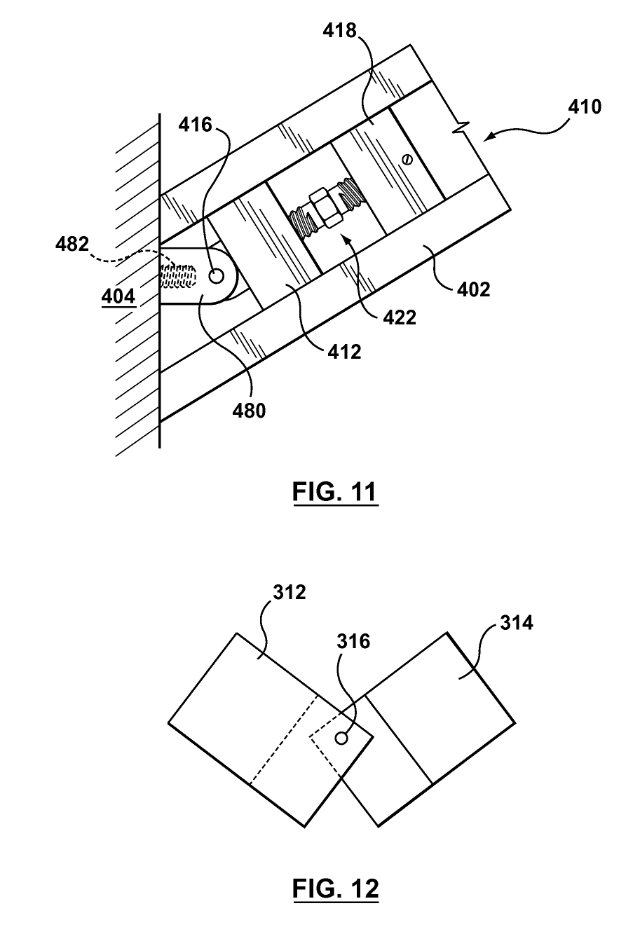

It will be noted that the pivot point in the examples illustrated above has been shown along a center axis of the connector members 12, 14. In other examples, the pivot point may be off-center. Reference is now made to FIG. 12, which shows a plan view of two connector members 312, 314 and a pivot axis 316 located off the center axis of the two members 312, 314.

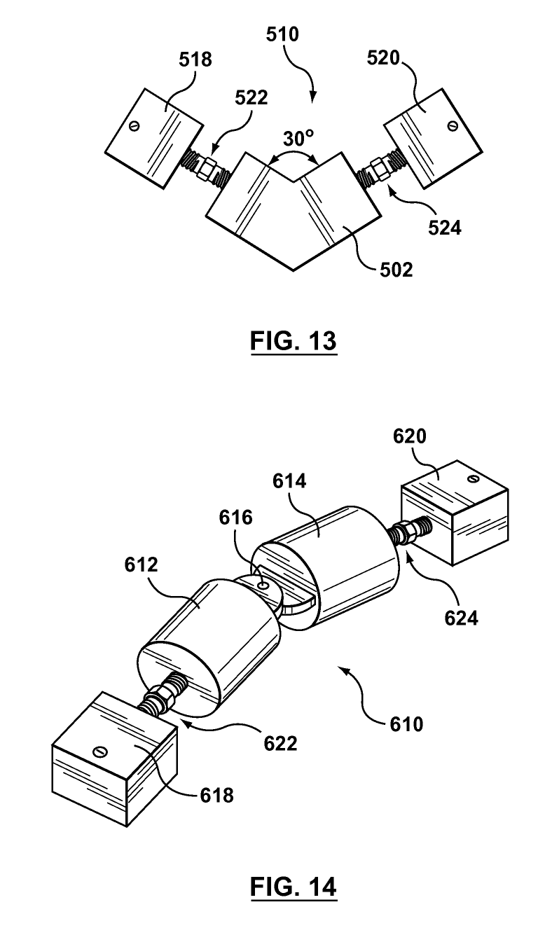

It will be appreciated that the pivot point between the connector members 12, 14 may be fixed in some embodiments. That is, the connector members 12, 14 may, in some cases, be permanently fixed in an angular relation to realize common angles, such as 45°, 30°, 0° (straight—no angle), etc. In such a case the two connector members 12, 14 may be formed as a single connector member. An example connector 510 with a fixed angle of 30° is shown in plan view in FIG. 13. In this example, the connector 510 includes anchor members 518 and 520 and fasteners 522 and 524. The connector 510 further includes a single piece connector member 502 that provides the fixed 30° angle.

In yet another embodiment, the connector may be configured to produce compound angles between framing members. Reference is now made to FIG. 14, which shows a perspective view of an example connector 610 for compound angles. In this example, the framing members are presumed to have a regular internal polygonal profile. Examples include circular, square, hexagonal, etc. The connector 610 includes cylindrical first and second connector members 612 and 614. In this embodiment, first and second anchor members 618 and 620 are non-cylindrical. In particular, in this embodiment, the anchor members 618 and 620 have a cross-sectional profile that corresponds to the interior profile of the framing members (not shown), which in this case is square. This facilitates anchoring of the anchor members 618, 620 and prevents accidental axial rotation of the anchor members 618, 620. Conversely, the connector members 612, 614 have a circular cross-sectional profile. Although the diameter of the circular profile may be smaller than the interior width dimension of the square framing member, the connector 610 will be more secure if the diameter is equal to or slightly smaller than the square profile so that the connector members 612, 614 are free to rotate axially when the connector 610 is being installed and secured.

The connectors 612, 614 are attached at a pivot point, through which an axle 616 may, in some cases, be inserted. Accordingly, the two connector members 612, 614 can pivot relative to each other in one plane. To create the compound angle, the connector members 612, 614 are capable of rotating axially relative to their respective anchor members 618, 620.

The connector 610 is used with two framing members whose ends are cut with a compound miter saw, for example. The connector 610 is inserted into the framing members and the framing members are brought end-to-end at the desired angle to have the mitered planes meet. The connector members 612, 614 rotate within the framing members such that the pivot axis is brought into alignment with and lies in the plane of the compound miter joint. The anchor members 618, 620 do not rotate within the framing members, but the connector members 612, 614 are able to rotate because of the rotation of fasteners 622, 624. Once the framing members are aligned so that the connector members 612, 614 have assumed the correct axial rotation, then the anchor members 618, 620 may be secured in place within the framing members and the fasteners 618, 620 used to tighten the structure to the desired degree.

It will be appreciated that the foregoing description of the compound angle connector 610 presumes a regular polygonal interior profile for the framing members. The connector 610 may be used with an irregular framing member, such as a rectangular profile member, but the cylindrical connector members 610 may only end up contacting up to three interior surfaces within the framing member.

In one variation, another embodiment of the connector 610 may be used with framing members that have irregular polygonal interior profiles. The other embodiment still uses cylindrical connector members 612, 614, but the fasteners 622, 624 are not axially-centered at both the connector members 612, 614 and the anchor members 618, 620. The fasteners 622, 624 are axially-centered with respect to the connector members 612, 614, thereby permitting them to rotate relative to that axis. However, the fasteners 622, 624 are offset from the axial center of the anchor members 618, 620. In one case, the fasteners are spaced equidistant from the two long sides of a rectangular anchor member and a distance from the short side, where the distance is equivalent to the radius of the cylindrical connector member. In such an arrangement, the cylinder is assured of being adjacent the same side surface of the interior of the framing member that the anchor member abuts. The anchor members are inserted into the irregular polygonal framing members such that the side of the anchor member closest to the fastener corresponds to the side of the framing member at the “inner” side of the compound miter cut (i. e. the shorter side of the miter cut forming part of the interior angle of the compound structure).

In one example embodiment, rather than attaching a framing piece to another framing piece, the connector may be configured to attach a framing piece to a surface. Reference is now made to FIG. 11, which shows a side view of one embodiment of a connector 410 for securing a framing piece 402 to a surface 404. In this embodiment, the framing piece 402 is a c-channel framing piece with a mitered end intended to be attached flush to the surface 404.

The connector 410 includes a connector member 412, anchor member 418, fastener 422, and lock element 426. The connector member 412 includes a pivot point provided by a shaft 416. The connector 410 further includes a surface anchor 480. The surface anchor 480 includes a corresponding aperture for receiving the shaft 416. The surface anchor 480 also includes a threaded aperture for attachment to a bolt extending from the surface 404. The surface anchor 480 may be screwed onto the surface 404 using the bolt. The remainder of the connector 10 is then inserted into the framing piece 402, the end of which is brought into abutting relation with the surface 404. The connector 10 is then secured to the framing piece 402 using the lock element 426 and the connection is tightened using the fastener 422.

It will be understood that the fasteners 22, 24 of connector 10 are not only usable to draw framing pieces together in a tight butt joint, but also to hold them spaced apart by a fixed gap when desirable.

Advantageously, because the fasteners 22, 24 permit fine adjustment, an installer working on a complex overall framing structure with multiple joints (e.g. a complex handrail installation or complex structural frame) is able to adjustably tighten individual joints of the overall framing structure after full assembly of the multiple pieces.

It will also be understood that the framing pieces need not have an axial channel that runs their full length. To accommodate insertion of the connector, the axial channel may only be present at an end of the framing piece.

The framing pieces may be formed from metal, plastic, wood, or other suitable building materials. The connector may be formed from metal, plastic, combinations of metal and plastic, or other suitable materials.

Certain adaptations and modifications of the described embodiments can be made. Therefore, the above discussed embodiments are considered to be illustrative and not restrictive.

1. A connector configured to connect a first and second framing piece end-to-end at an angle, each framing piece having an axial channel that defines an opening in an end of that framing piece, the connector comprising:
a first connector member and a second connector member each having a pivot end, the pivot ends being pivotally attached to each other, wherein the first connector member and the second connector member each have a cross-sectional profile configured to fit within the axial channel of the respective framing pieces;
a first anchor member having a cross-sectional profile configured to fit within the axial channel of the first framing piece and having a lock element for securing the first anchor member in place within the first framing piece;
a second anchor member having a cross-sectional profile configured to fit within the axial channel of the second framing piece and having a lock element for securing the second anchor member in place within the second framing piece;
a first fastener to attach the first connector member to the first anchor member an adjustable longitudinal distance apart; and
a second fastener to attach the second connector member to the second anchor member an adjustable longitudinal distance apart.

2. The connector claimed in claim 1, wherein the lock elements comprise set screws.

3. The connector claimed in claim 1, wherein the pivot end of one of the first connector member and second connector member is nested within the pivot end of the other of the first connector member and second connector member.

4. The connector claimed in claim 1, wherein the fasteners each comprise a double-sided bolt and each of the anchor members and connector members include threaded apertures to receive the double-sided bolt.

5. The connector claimed in claim 4, wherein the double-sided bolt comprises a central driving portion and threaded ends.

6. The connector claimed in claim 5, wherein one of the threaded ends of the fastener is right-hand threaded and the other of the threaded ends is left-hand threaded.

7. The connector claimed in claim 5, wherein the central driving portion includes a plurality of key holes in the surface of the central driving portion and spaced around the circumference of the central driving portion.

8. The connector claimed in claim 1, wherein the fasteners each comprise a bolt, wherein each of the anchor members includes an axial through hole, and wherein the bolts pass through the respective through holes and screw into respective threaded holes in the respective connector members.

9. The connector claimed in claim 1, wherein the framing pieces comprise c-channel framing pieces, and wherein abutting ends of the framing pieces are mitered ends.

10. A connector configured to connect a framing piece to another element, the framing piece having an axial channel that defines an opening in an end of that framing piece, the connector comprising:
a pivot member;
a connector member having a pivot end, the pivot end being pivotally attached to the pivot member, wherein the connector member has a cross-sectional profile configured to fit within the axial channel of the framing piece;
an anchor member having a cross-sectional profile configured to fit within the axial channel of the framing piece and having a lock element for securing the anchor member in place within the framing piece; and
a fastener to attach the connector member to the anchor member an adjustable longitudinal distance apart.

11. The connector claimed in claim 10, wherein the lock element comprises a set screw.

12. The connector claimed in claim 10, wherein the fastener comprises a double-sided bolt and the anchor members and the connector member each have a threaded aperture to receive the double-sided bolt.

13. The connector claimed in claim 12, wherein the double-sided bolt comprises a central driving portion and threaded ends.

14. The connector claimed in claim 13, wherein one of the threaded ends of the fastener is right-hand threaded and the other of the threaded ends is left-hand threaded.

15. The connector claimed in claim 13, wherein the central driving portion includes a plurality of key holes in the surface of the central driving portion and spaced around the circumference of the central driving portion.

16. The connector claimed in claim 10, wherein the fastener comprises a bolt, wherein the anchor member includes an axial through hole, and wherein the bolt passes through the through hole and screws into a threaded hole in the connector member.

17. A railing system, the railing system comprising:
a first rail formed from a framing member having an axial channel that defines an opening in an end of that framing member;
a second rail formed from a framing member having an axial channel that defines an opening in an end of that framing member; and
a connector having a profile that fits within the axial channels for connecting the first rail and second rail end-to-end, the connector including:
a first connector member and a second connector member each having a pivot end, the pivot ends being pivotally attached to each other,
a first anchor member having a lock element for securing the first anchor member in place within the first framing piece,
a second anchor member having a lock element for securing the second anchor member in place within the second framing piece,
a first fastener to attach the first connector member to the first anchor member an adjustable longitudinal distance apart, and
a second fastener to attach the second connector member to the second anchor member an adjustable longitudinal distance apart.

18. The railing system claimed in claim 17, wherein the pivot end of one of the first connector member and second connector member is nested within the pivot end of the other of the first connector member and second connector member.

19. The railing system claimed in claim 17, wherein the fasteners each comprise a double-sided bolt and each of the anchor members and connector members include threaded apertures to receive the double-sided bolt, wherein the double-sided bolt comprises a central driving portion and threaded ends.

20. A connector configured to connect a first and second framing piece end-to-end at an angle, each framing piece having an axial channel that defines an opening in an end of that framing piece, the connector comprising:
an angle connector having a first arm and a second arm joined at an angle;
a first anchor member having a cross-sectional profile configured to fit within the axial channel of the first framing piece and having a lock element for securing the first anchor member in place within the first framing piece;
a second anchor member having a cross-sectional profile configured to fit within the axial channel of the second framing piece and having a lock element for securing the second anchor member in place within the second framing piece;
a first fastener to attach the first arm of the angle connector to the first anchor member an adjustable longitudinal distance apart; and
a second fastener to attach the second arm of the angle connector to the second anchor member an adjustable longitudinal distance apart.
